(19) United States
(12) Patent Application Publication
(10) Pub. No.: US 2018/0311855 A1
(43) Pub. Date: Nov. 1, 2018

(54) Scoring and Slicing Apparatus

(71) Applicant: Gunntech Manufacturing, Inc., Hayden, ID (US)

(72) Inventors: Dalen E. Gunn, Coeur D'Alene, ID (US); Nathaniel P. Brand, Coeur D'Alene, ID (US)

(73) Assignee: Gunntech Manufacturing, Inc., Hayden, ID (US)

(21) Appl. No.: 15/582,810

(22) Filed: May 1, 2017

(51) Int. Cl. B26D 7/26; B26D 1/45; B26D 3/08; B26D 7/01

(52) U.S. Cl. CPC B26D 7/2635; B26D 7/015; B26D 3/085; B26D 1/455

(57) ABSTRACT

An apparatus for cutting a workpiece, the apparatus having a pair of spaced apart rails fixed to a handle, the rails extending away from the handle in a first direction, a guide carriage slidingly engaged with the rails, a blade carriage slidingly engaged with the rails between the handle and the guide carriage, a pair of runners for supporting the workpiece, one of the runners joined with the handle and a second one of the runners joined with the guide carriage, the runners extensive in a second direction non-parallel to the first direction, and a cutting blade engaged with the blade carriage in a position for cutting into the workpiece during relative movement between the apparatus and the workpiece. With the guide carriage adjusted for receiving the workpiece on the runners between the guide carriage and the handle, the blade carriage is adjusted to a location for severing the workpiece.

### FIELD OF THE DISCLOSURE

The described apparatus relates to manually operated tools, and more particularly, to tools that are used for scoring and slicing actions, and especially for use with workpieces made of sheet or plank stocks of paper, fabric, wood, plastic, metal, ceramic, glass and like materials.

### BACKGROUND

Sheet material cutting devices are known in the art. One such device is described in Keeton, U.S. Pat. No. 3,213,736 for cutting mats. The latter mat cutting device employs an elongated tie bar which is supported by end located arms. The arms in turn are pivotally mounted on a working board to lift the tie bar with its cutter elements and place a mat underneath on the working surface. The cutting elements slide along a rail located in the tie bar and are disposed on opposite sides of the tie bar to respectively provide either a straight or beveled cut. Another sheet material cutting apparatus is described in Matthew, U.S. Pat. No. 3,774,495. In this patent, a key-shaped cutting arrangement is shown to provide guide surfaces, one of which supports a cutting block. The cutting block is mounted to enclose this guide surface. The material to be cut abuts against a stop plate carrying a scale and a scale is moved along with the cutting block itself. In Broides, U.S. Pat. No. 3,779,119, a mat cutting apparatus is described wherein a cutting element is mounted on a guide rail. Other U.S. patents of interest and describing various devices for cutting sheet material are: Wensink, U.S. Pat. No. 2,696,867; Melchor, U.S. Pat. No. 2,531,149 in-connection-with a floor tile cutting device; and Katz, U.S. Pat. No. 3,576,148 which describes a device for forming a strip mat. The prior art fails to teach a manually operated apparatus for longitudinally scoring and slicing materials of arbitrary length. Furthermore, the prior art does not provide a means of quickly latching the guiding and score/cutting mechanisms when placed in-close-proximity to the workpiece being cut. Finally, the prior art does not describe a guide system which is adjustable to match the width of a selected workpiece and to hold the workpiece on a true linear cutting direction.

### SUMMARY

A portable, hand held, manually operated, apparatus is used for scoring and slicing a workpiece, for instance: semi-rigid, fibrous, and/or resilient sheet or plank materials. The apparatus has a handle, a pair of rails secured to the handle, a blade carriage which slides along the rails into a desired cutting position. Opposing workpiece guides have runners for supporting the workpiece. One of the workpiece guides is attached to a guide carriage which slides along the rails to a position for spacing the workpiece guides a workpiece-width apart. A blade cartridge is mounted in the blade carriage and is vertically adjustable. A keen edged blade is mounted in the blade cartridge and protrudes downwardly for engagement with the workpiece. The degree of engagement depends on the desired depth of scoring or slicing into the workpiece. Examples of blade adjustment mechanisms that may be used include: screw-follower pairs, rack-and pinion apparatus with latching or ratcheting members, and detent-latching shafts among other well-known solutions. Two latches are used, one attached to the blade carriage and the other attached to the guide carriage. Both latches engage one of the rails to act as a brake preventing carriage motion when engaged and to allow carriage motion when disengaged. Examples of latches that may be used for this function include: cam-action clamps, detent latching pins, screw-driven clamps, and spring-driven clamps, among other well-known solutions. In use, with the latches disengaged, the guide carriage is movable along the rails to set the workpiece guides by a distance apart that enables the workpiece to enter between the workpiece guides, and then the guide carriage latch is engaged to hold that spacing. The blade carriage is moved along the rails between the workpiece guides to a desired cut position and the blade carriage latch is then engaged to hold the blade carriage at that location during scoring and slicing operations. In order to adjust a depth of cut, the blade cartridge position is adjusted vertically by rotating a blade adjustment knob positioned on top of the blade carriage. The workpiece guides and runners constrain the workpiece for linear cutting motion by pushing the apparatus along the workpiece. One object of the described apparatus is to be able to score and slice or cut the aforementioned-types of workpieces as well as similar and related materials. Another object of the apparatus is to provide a tool that enables scoring, slicing, and cutting such workpiece materials along a linear path without requiring undue attention or skill by an operator. A further object of the apparatus is to provide a tool with quick adjustment of a location and depth of cut in a workpiece. A still further object of the apparatus is to provide a tool that enables receiving and controlling a wide range of workpiece widths. A still further object of the apparatus is to provide a tool that enables cutting a workpiece of any length without changing tool set-up, as long as the workpiece' s width remains constant over its length. In this disclosure, the terms “a” or “an” are used, as is common in patent documents, to include one or more than one. Furthermore, the term “or” is used to refer to a nonexclusive “or,” such that “A or B” includes “A but not B,” “B but not A,” and “A and B,” unless otherwise indicated.

### BRIEF DESCRIPTION OF THE DRAWINGS

Embodiments of the described apparatus are illustrated only as examples in the figures of the accompanying drawing sheets wherein the same reference numeral refers to the same element as it may appear in several drawing sheets.

FIG. 1 is a perspective view of an embodiment of the described and claimed apparatus.

FIG. 2 is a left side elevation view thereof.

FIG. 3 is a top plan view thereof.

FIG. 4 is a rear elevation view of the apparatus showing workpiece placement.

FIG. 5 is a section view taken along line A-A of FIG. 3.

FIG. 6 is an exploded elevation view of a blade carriage assembly, a blade holder, and supporting hardware.

FIG. 7 is an exploded perspective view of the blade holder.

FIG. 8 is a side elevation view of the blade holder.

FIG. 9 is a section view taken along line B-B of FIG. 8.

FIG. 10 is a bottom view of the blade holder.

### DETAILED DESCRIPTION OF THE APPARATUS

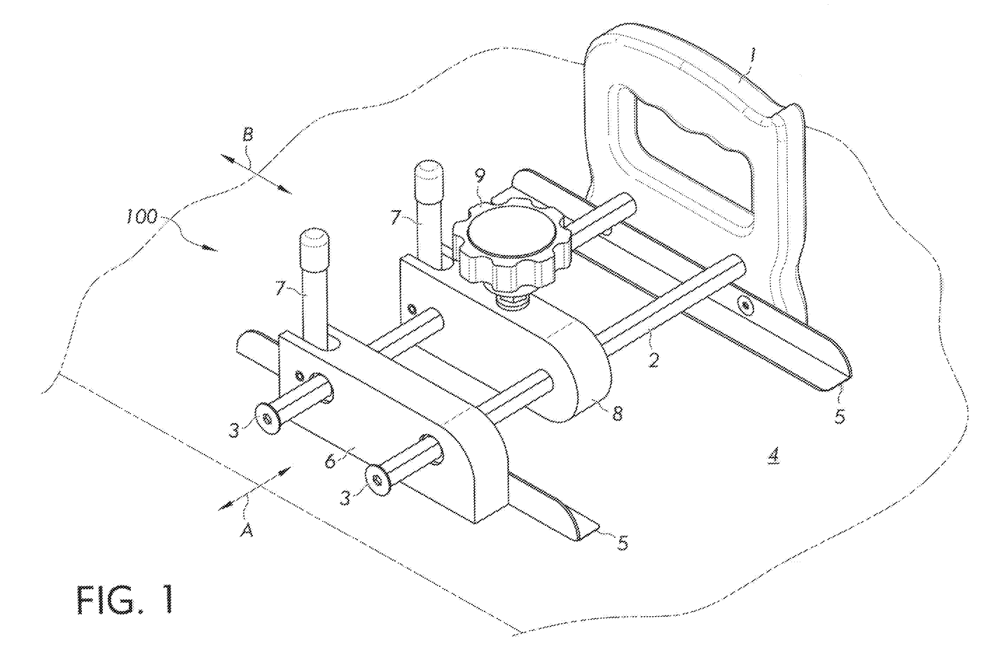

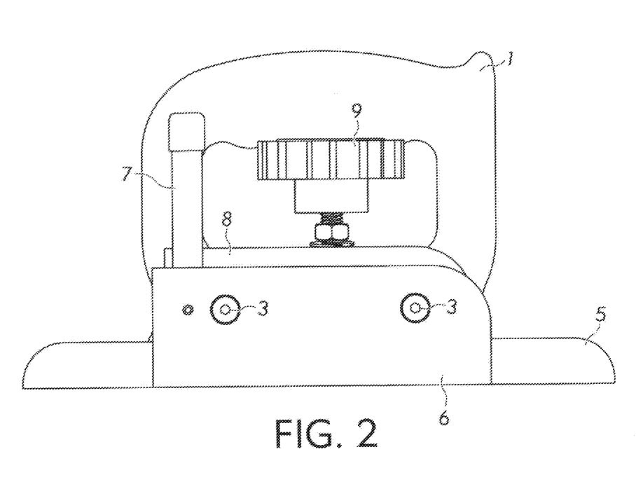

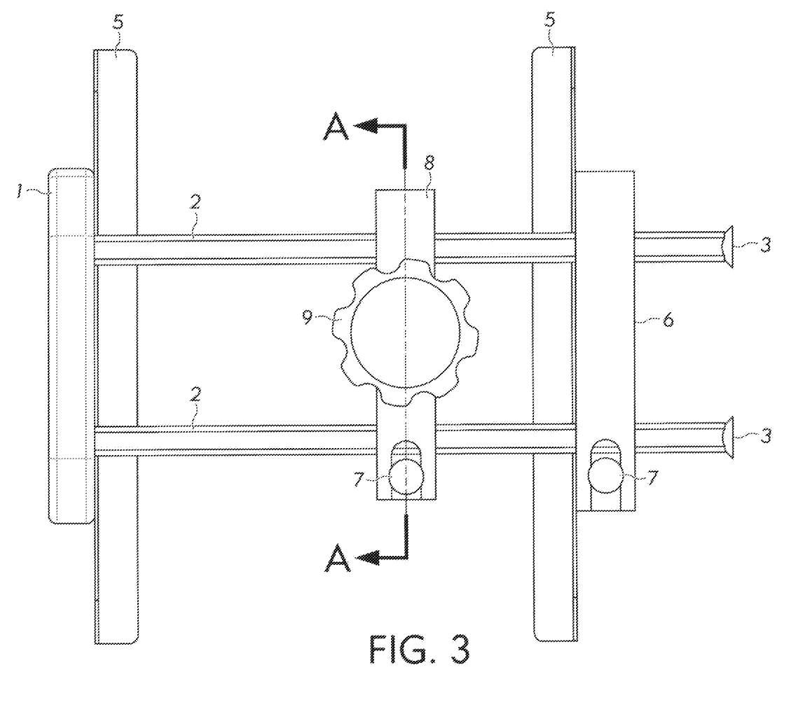

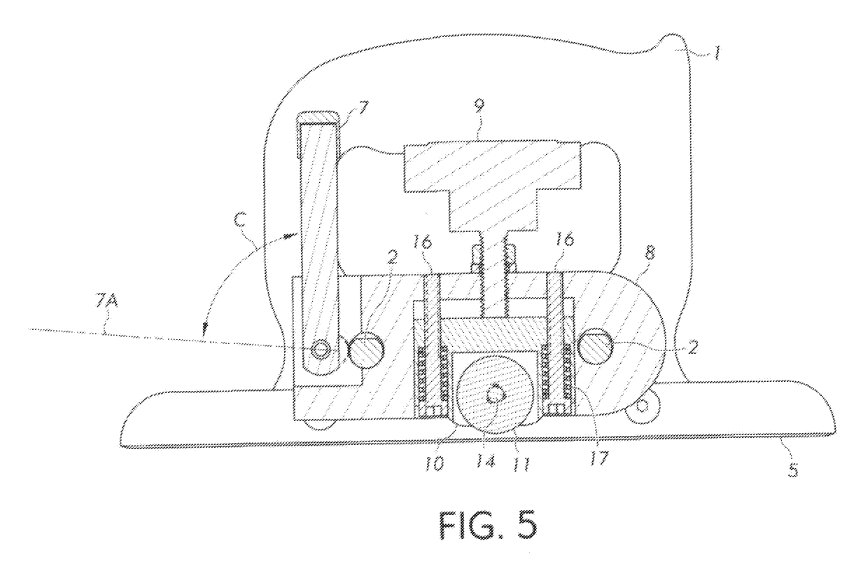

Described in detail now is a scoring and slicing apparatus, (“apparatus 100”) as best seen in FIG. 1. The term “scoring” herein refers to an action of cutting part-way into a workpiece 110 (see FIG. 5). The term “slicing” herein refers to an action of cutting completely through workpiece 110 thereby fully severing it, and is equivalent herein to the term “cutting.” The term “cutting” is used in this description to refer to scoring, slicing, and severing.

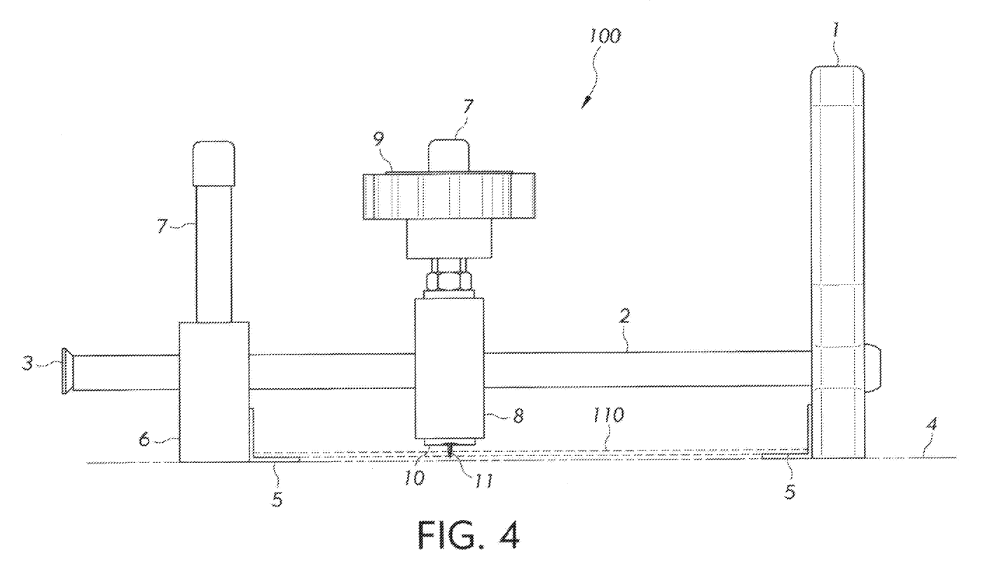

Referring now to the drawing figures described above and which drawing sheets are made a part of this specification, it should be recognized that apparatus 100 is used for cutting workpiece 110. As shown in FIG. 1, apparatus 100 may have a pair of spaced apart rails 2 which may be fixed to a handle 1 by any mechanical means wherein rails 2 may extend away from handle 1 in a first direction defined by arrow “A.” Potentially, a single rail 2 may be used or more than two rails 2 may be used in alternate embodiments, however, two rails 2 have been found to be sufficient and effective in meeting the objectives of apparatus 100. A guide carriage 6 may be slidingly engaged with rails 2, as shown, so that carriage 6 is able to move in direction “A” for being positioned selectively on rails 2. As further shown in FIG. 1, rails 2 may have termination elements 3 such as common hardware items, for preventing guide carriage 6 from disengaging from rails 2. A blade carriage 8 may also be slidingly engaged with rails 2 and may be positioned between handle 1 and guide carriage 6 so that it also is able to move in direction “A” for being positioned selectively on rails 2 for cutting workpiece 110 at a selected location. It should be understood that more than one blade carriage 8 may be mounted on rails 2 between handle 1 and guide carriage 6 so that they also are able to move in direction “A” for being positioned selectively on rails 2 for cutting workpiece 110 at multiple selected locations simultaneously. Although not shown in the drawing figures, those of skill will be able to modify the embodiment of FIG. 1 to achieve this alternate embodiment. An L-shaped runner 5 may be mounted on handle 1 and a second L-shaped runner 5 may be mounted on guide carriage 6 as shown in FIG. 1. Runners 5 may be mounted respectively by common hardware or by other mechanical means. Runners 5 are used for supporting and guiding apparatus 100 along workpiece 110 as shown in FIG. 4. It should be recognized that workpiece 110 is positioned on runners 5 between guide carriage 6 and handle 1. Runners 5 are extensive in a second direction which is shown by arrow “B” in FIG. 1 and it is this direction that apparatus 100 is moved when cutting workpiece 110. Second direction “B” is non-parallel to first direction “A” and may preferably be orthogonal thereto but may alternately form an angle of less than 90° relative to direction “A”. It should be recognized that handle 1, runners 5 and both blade carriage(s) 8 and guide carriage 6 may be set at a mutual acute angle relative to rails 2. Although not shown in the drawing figures, those of skill will be able to modify the embodiment of FIG. 1 to achieve this alternate embodiment. As shown in FIG. 4, cutting blade 11 may be engaged with blade carriage 8 in a position for cutting into workpiece 110 (best shown in FIG. 4) during relative movement between apparatus 100 and workpiece 110.

As shown in the several figures a first latch 7 may be secured to guide carriage 6 and a second latch 7 may be secured to blade carriage 8. As shown in FIG. 5 latches 7 may be moved, as shown by arrow “C”, between a non-engaged upright attitude and an engaged position identified by reference line 7A. When in the engaged position the lower curved end of latch 7 (shown in phantom line) contacts rail 2 preventing blade carriage 8 from moving along rail 2. The same action is operational for latch 7 at guide carriage 6. Therefore, arrow “C” shows the possible movement of latch 7 between its alternate positions. As shown, latches 7 may be linearly extensive with a first end (upper portion) that may be used as a handle and a second curved end (lower portion) that may be used for frictional or interference contact with rail 2 when latch 7 is in its engaged position shown by line 7A as previously discussed.

Guide carriage 6 is moved along rails 2 so that the space between runners 5 is approximately equal to the width of workpiece 110 and then it is locked in position by latch 7. Next, blade carriage 8 is positioned at a location on workpiece 110 where cutting is desired and then latch 7 is engaged. In the field, a worker may push handle 1 in direction “B” thereby moving apparatus 100 along workpiece 110 to cut or score it. In a factory or shop setting, apparatus 100 may be secured at a fixed location and workpiece 110 may then be fed through apparatus 100 continuously in order to cut or score it.

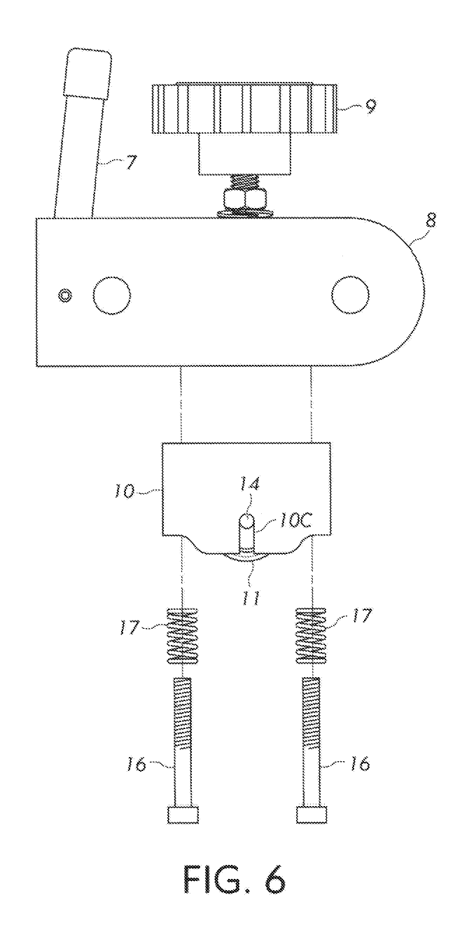

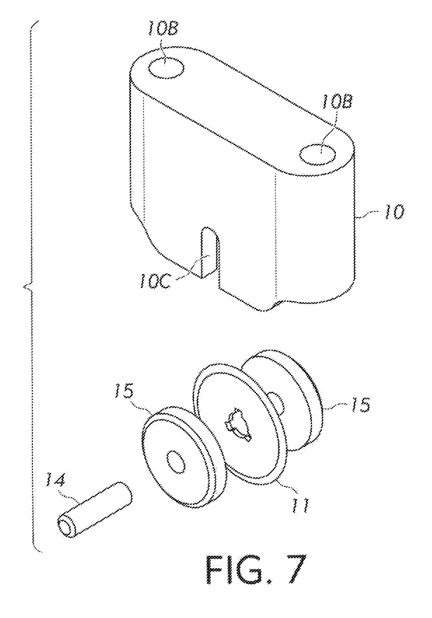

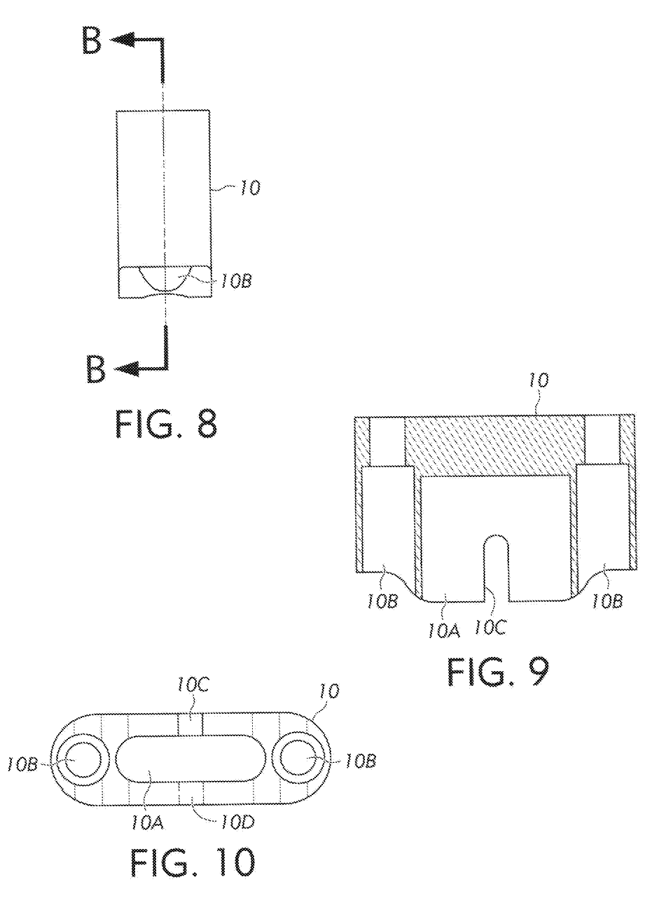

As shown in FIG. 5, a blade holder 10 may be engaged within blade carriage 8. FIGS. 5 and 6 show that blade holder 10 may be secured to blade carriage 8 by hardware including screws 16 and springs 17. FIGS. 5 and 7 show that blade holder 10 receives blade 11, washers 15 and axle pin 14. In an embodiment shown by FIGS. 8-10 we see that blade holder 10 may have a blade pocket 10A, a pair of adjustment channels 10B, a pin mounting slot 10C and a pin mounting hole 10D. Cutting blade 11 and its two washers 15 may be engaged within blade pocket 10A by axle pin 14. Fasteners 16 and coil springs 17 may be engaged within adjustment channels 10B as shown in FIG. 5. FIG. 5 also illustrates the position and extent of a depth-of-cut knob 9 which is threaded into blade carriage 8, as shown, wherein a threaded shaft of depth-of-cut knob 9 contacts blade holder 10, wherein rotation of depth-of-cut knob 9 positions blade holder 10 and cutting blade 11 vertically.

In the foregoing description, embodiments are described as a plurality of individual parts, and methods as a plurality of individual steps and this is solely for the sake of illustration. Accordingly, it is contemplated that some additional parts or steps may be added, some parts or steps may be changed or omitted, and the order of the parts or steps may be re-arranged, while maintaining the sense and understanding of the apparatus and methods as claimed.

What is claimed is:

1. An apparatus for cutting a workpiece, the apparatus comprising:
a pair of spaced apart rails fixed to a handle and extending away therefrom in a first direction;
a guide carriage slidingly engaged with said rails;
a blade carriage slidingly engaged with said rails between said handle and said guide carriage;
a pair of runners for supporting said workpiece, one of said runners joined with said handle and a second one of said runners joined with said guide carriage, said runners extensive in a second direction, said second direction non-parallel to said first direction; and
a cutting blade engaged with said blade carriage in a position for cutting into said workpiece during relative movement between said apparatus and said workpiece.

2. The apparatus of claim 1 further comprising a first latch secured to said guide carriage and a second latch secured to said blade carriage, wherein said latches are movable between an engaged position inhibiting movement relative to said rails, and a disengaged position not inhibiting movement relative to said rails.

3. The apparatus of claim 2 wherein each one of said latches is linearly extensive with a first end thereof functional as a handle and with a second end thereof curved for frictional contact with one of said rails when said latch is in said engaged position.

4. The apparatus of claim 1 wherein a blade holder is secured within said blade carriage.

5. The apparatus of claim 4 wherein said blade holder has a blade pocket and an adjustment channel, said cutting blade engaged within said blade pocket and a fastener engaged within said adjustment channel.

6. The apparatus of claim 5 wherein a coil spring is engaged with said fastener.

7. The apparatus of claim 6 wherein a depth-of-cut knob is engaged with said blade carriage, in contact with said blade holder, wherein rotation of said depth-of-cut knob adjusts a position of said cutting blade.

8. The apparatus of claim 4 wherein said blade holder has a blade pocket and opposing adjustment channels, said cutting blade engaged within said blade pocket and a fastener engaged within each of said adjustment channels.

9. The apparatus of claim 8 wherein a coil spring is engaged with each said fastener.

10. The apparatus of claim 9 wherein a depth-of-cut knob is engaged with said blade carriage, in contact with said blade holder, wherein rotation of said depth-of-cut knob adjusts a position of said cutting blade.

11. A method for cutting a workpiece with an apparatus having a pair of spaced apart rails fixed to a handle and extending away therefrom in a first direction, a guide carriage slidingly engaged with said rails, a blade carriage slidingly engaged with said rails between said handle and said guide carriage, a pair of runners for supporting said workpiece, one of said runners joined with said handle and a second one of said runners joined with said guide carriage, said runners extensive in a second direction, said second direction non-parallel to said first direction;
and a cutting blade engaged with said blade carriage in a position for cutting into said workpiece during relative movement between said apparatus and said workpiece, the method comprising:
moving said guide carriage on said rails to position said runners apart by the width of said workpiece;
moving said blade carriage on said rails to position said cutting blade selectively for cutting said workpiece;
adjusting said cutting blade relative to said workpiece selectively for a desired depth of cut into said workpiece;
positioning said workpiece on said runners; and
moving said apparatus along said workpiece thereby cutting said workpiece by said cutting blade.
